(19) United States
(12) Patent Application Publication
(10) Pub. No.: US 2009/0091116 A1
(43) Pub. Date: Apr. 9, 2009

(54) Vehicle-shaped book

(76) Inventor: Christian Legrand, Nonthaburi (TH)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/973,058

(22) Filed: Oct. 5, 2007

(51) Int. Cl. B42D 1/00; A63H 17/00

(52) U.S. Cl. 281/15.1; 281/21.1; 446/71; 446/465

(57) ABSTRACT

An improved vehicle-shaped book includes a lower chassis body, an upright book support strut and at least two book pages, each page including a middle foam plate and front and back semi-rigid paper plates mounted on and sandwiching the middle foam plate, the book pages bound to adjacent pages thereof in a book format, the book pages mounted on the upright book support strut generally perpendicular to the longitudinal axis of the lower chassis body and front and rear wheels rotatably mounted on the lower chassis body whereby the vehicle-shaped book is rollable on the wheels.

### BACKGROUND OF THE INVENTION

1. Technical Field

The present invention is directed to books having foam-based pages and, more particularly, to an improved vehicle-shaped book which includes a lower chassis body, an upright book support strut and at least two book pages, each page including a middle foam plate and front and back semi-rigid paper plates mounted on and sandwiching the middle foam plate, the book pages bound to adjacent pages thereof in a book format, the book pages mounted on the upright book support strut generally perpendicular to the longitudinal axis of the lower chassis body and front and rear wheels rotatably mounted on the lower chassis body whereby the vehicle-shaped book is rollable on the wheels.

2. Description of the Prior Art

There are many different kinds of books and book bindings which are currently used in the publishing industry. While the majority of books are constructed of paper and paper products, there are many different types of children's books which are constructed of different materials such as cloth, foam, or other such materials, in order to provide additional tactile sensations for the children reading the books. Recently, one of the more popular types of manufacturing materials used in connection with children's books are thin plates of foam which constitute the pages and front and rear covers of the children's books. These are bound together in many different ways and assembled to form many different shapes and sizes of children's books, but in general, these function only as books and not as toys which can be played with. Of course, this is not a disadvantage when there is no intent to use the books as toys, but it would significantly add to the enjoyment of the book if it could also be used as a toy and not just as a book.

One of the most popular subjects for children's books involve vehicles of many different sizes and shapes. For example, books about the many different types of trucks are very popular with boys and girls of ages two to ten, and this is why there are numerous children's books on this subject. However, it is also true that the level of excitement and interest generated by such books is limited in that the child cannot physically experience what it is like when a vehicle is in motion. To experience this, the child must play with various kinds of vehicular toys which replicate the much-larger versions which travel on our streets and highways. It is believed, however, that it would be truly exciting and interesting for a child if he or she were not only able to read about various types of vehicles in a book, but also play with the book as a toy which replicates at least one of the vehicles which are displayed within the book. There is therefore a need for such a vehicle-shaped book which also functions as a toy.

However, it has also been found that the presently available vehicle-shaped books utilize pages which extend generally parallel with the direction of travel of the vehicle, and these books are limited in the configurations and shapes that they can form if the functionality of the book portion is to be maintained. There is therefore a need for a vehicle-shaped book which includes pages which are orientated in a different direction and configuration than those which are currently available.

Therefore, an object of the present invention is to provide an improved vehicle-shaped book which includes wheels to allow the book to function both as a book and a toy.

Another object of the present invention is to provide an improved vehicle-shaped book which includes lower chassis body having an upright book support strut and at least two book pages, each page preferably including a middle foam plate and front and back semi-rigid paper plates mounted on and sandwiching the middle foam plate, the book pages bound by a binder in a book format, the book pages support on the book support strut perpendicular to the longitudinal axis of the lower chassis body and front and rear wheels rotatably mounted on the lower chassis body whereby the vehicle-shaped book is rollable on the front and rear wheels.

Another object of the present invention is to provide an improved vehicle-shaped book which visually resembles a selected vehicle or device such as a robot, truck, car, airplane, or other such vehicle so that the child playing with the book may both learn about the devices or vehicles displayed on, by and within the book and also play with the vehicle thereby increasing their enjoyment and interest in the vehicle-shaped book.

Another object of the present invention is to provide a improved vehicle-shaped book which includes one or two front wheels and two rear wheels, with the rear wheels being powered by a mechanical or electric motor device to drive the vehicle-shaped book forwards.

Finally, an object of the present invention is to provide a improved vehicle-shaped book which is relatively simple and economical to manufacture and which is safe, effective, and efficient in use.

### SUMMARY OF THE INVENTION

The present invention provides an improved vehicle-shaped book which includes a lower chassis body having a center longitudinal axis and at least one wheel rotatably mounted on the lower chassis body, the wheel having a rotational axis extending generally perpendicularly to the center longitudinal axis whereby the lower chassis body travels in a direction generally parallel with the center longitudinal axis. A main book support strut is mounted on and extends upwards from the lower chassis body and at least two semi-flexible book pages are secured together by a book binding in a book format wherein the book pages are generally parallel with one another. At least one of the at least two semi-flexible book pages and the book binder are mounted on the main book support strut with the at least two book pages extending generally perpendicular to the center longitudinal axis of the lower chassis body whereby the at least two book pages extend generally perpendicularly to the direction of travel of the lower chassis body.

The present invention thus provides a substantial improvement over those books currently being manufactured and sold for use by children. For example, because the foam-based pages are safe and soft, it is unlikely that children playing with the present invention will be injured through contact with the invention. Furthermore, because the present invention not only can be used as a book but also can be played with by the child as a toy, it is far more likely that the child's interest will be maintained for a greater period of time than with those single use books and toys found in the prior art. Also, the fact that the pages of the book extend perpendicularly to the direction of travel of the vehicle permits many different configurations and appearance modifications not possible with those vehicle-shaped books found in the prior art, such as configuring the pages to resemble a friendly robot or other such device. Finally, it is believed that the combination of the book and toy features of the present invention will make reading and learning more enjoyable for the child, which is clearly the goal of educational toys and books. It is therefore seen that the improved vehicle-shaped book of the present invention provides a substantial improvement over those books found in the prior art.

### BRIEF DESCRIPTION OF THE DRAWINGS

FIG. 1 is a perspective view of the improved vehicle-shaped book of the present invention;

FIG. 2 is an exploded perspective view of the present invention showing the pages mounted on the upright book support strut;

FIG. 3 is a side elevational view;

FIG. 4 is a cutaway front elevational view showing the lower chassis body;

FIG. 5 is a perspective view of the present invention with the pages being viewed; and

FIG. 6 is a perspective view of an alternative embodiment of the present invention configured to resemble a friendly robot.

### DESCRIPTION OF THE PREFERRED EMBODIMENT

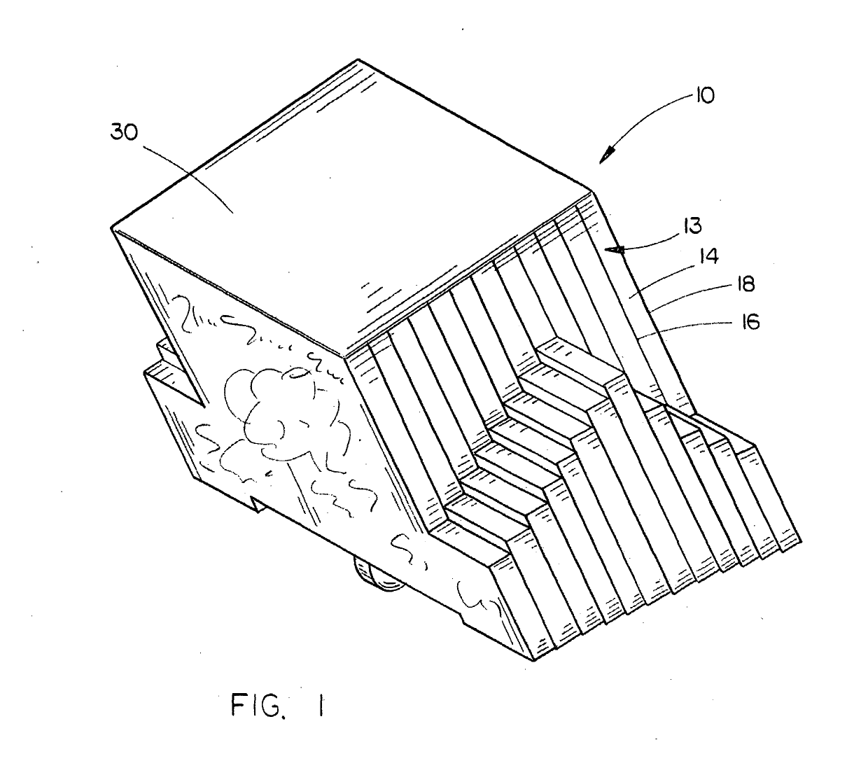

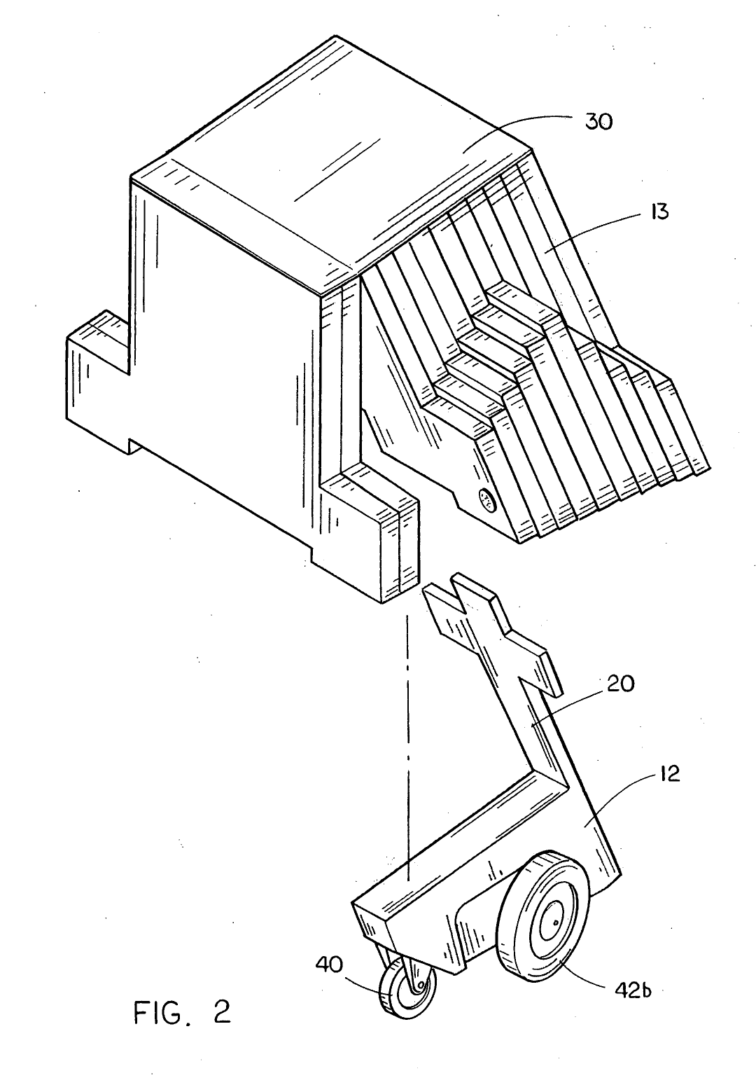

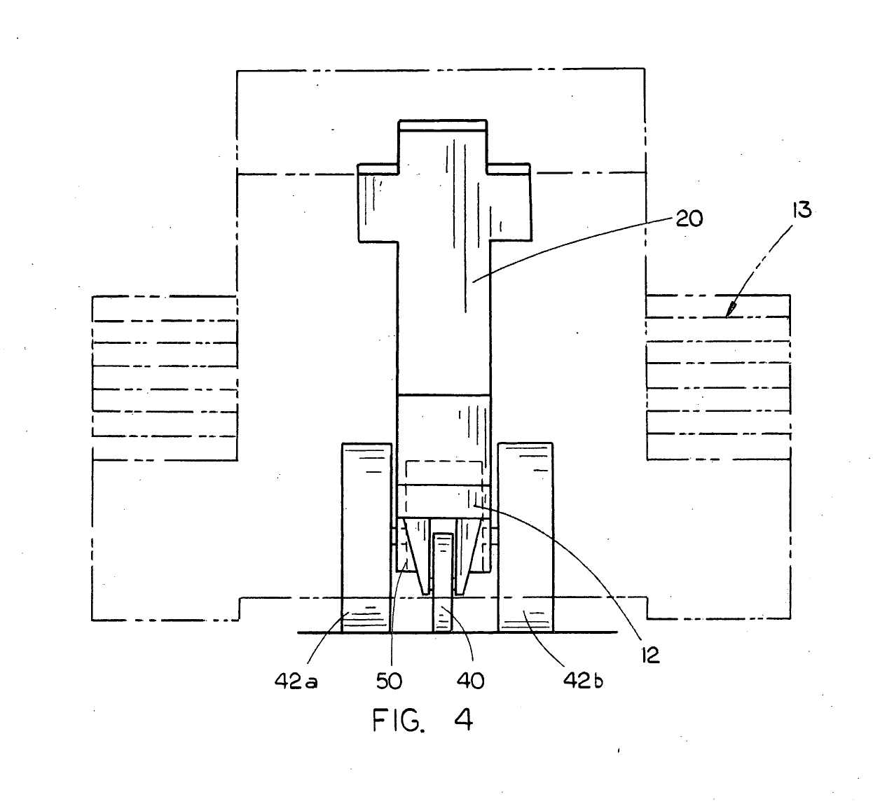

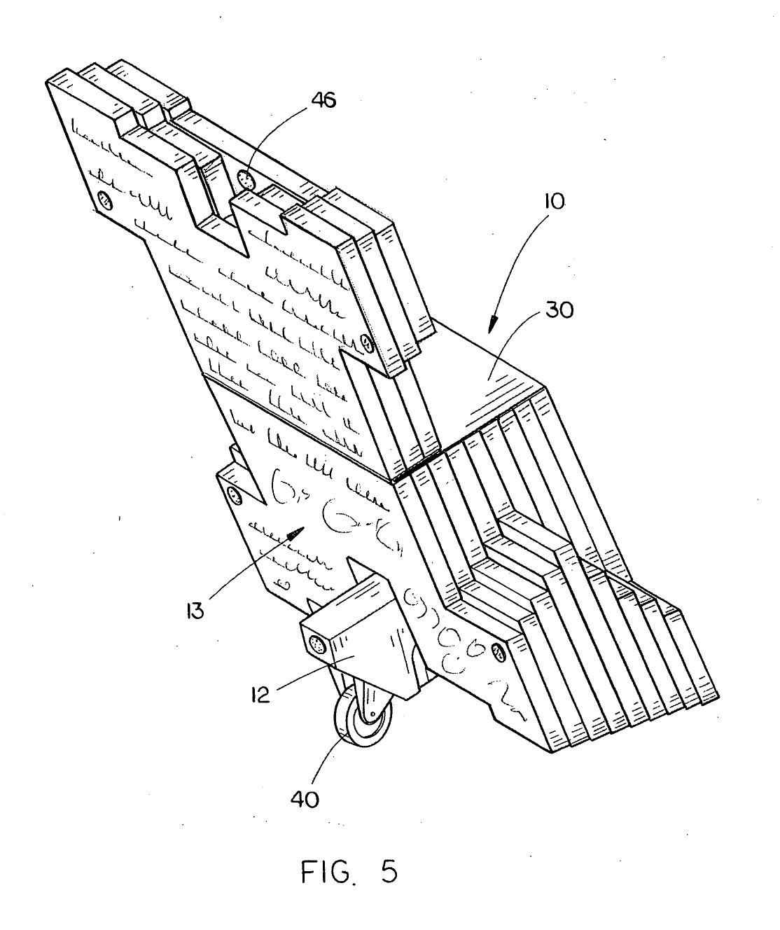

The vehicle-shaped book 10 of the present invention is shown best in FIGS. 1-5 as including a lower chassis body 12 which is preferably constructed as a molded plastic generally rectangular box, although the precise construction material used in connection with the lower chassis body 12 is not critical so long as the lower chassis body 12 provides a stable, sturdy chassis body for the vehicle-shaped book 10. The lower chassis body 12 further includes front wheel 40 and rear wheels 42a and 42b which, in the preferred embodiment, would be small plastic or rubber wheels which are mounted on axles extending through the lower chassis body 12 or mounted beneath lower chassis body 12 as the manufacturer may see fit. As shown in FIGS. 2 and 4, the front and rear wheels 40, 42a and 42b permit the vehicle-shaped book 10 of the present invention to be rolled forward or backwards for use as a toy truck, toy robot or other such toy vehicle, a feature which is not found in the prior art.

A plurality of book pages 13 are provided, each of which would preferably be constructed of a foam material in substantially the same manner. Specifically, each of the pages 13 would include a middle foam plate 14 and front and back semi-rigid paper plates 16 and 18, the front and back paper plates 16 and 18 secured to the middle foam plate 14 by an adhesive material or the like to ensure that the front and back paper plates 16 and 18 remain attached to the middle foam plate 14. In the preferred embodiment the middle foam plate 14 would preferably be constructed of a foam material, specifically the foam marketed under the common name “Eva Foam,” which is a polymer foam made of ethyl-vinyl acetate and which is non-toxic and resilient to tearing, and thus is quite safe for use with children. One of the advantages of Eva Foam is that it is pliable and thus is safe for use by children, but in the present invention, however, it is preferable to combine the foam plate with material more conducive for printing indicia and pictures thereon, and it is for this reason that the front and back paper plates 16 and 18 are mounted on the middle foam plate 14.

In the preferred embodiment, the front and back paper plates 16 and 18 would be constructed of a semi-rigid paper material such as cardstock or the like which would readily receive printed indicia thereon for printing of the book pages, and will also provide additional rigidity for the middle foam plate 14. Furthermore, it is important that the front and back paper plates 16 and 18 have dimensions slightly smaller than the middle foam plate 14 such that the middle foam plate 14 extends beyond the edges of the front and back paper plates 16 and 18, as shown best in FIGS. 1 and 2, thus ensuring that the edges of the pages 13 are foam, thus preventing paper cuts or other injuries to children using the present invention. A final important consideration for the pages 13 is that they may be constructed of virtually any size, shape, and thickness via die cut or other cutting method, which means that the vehicle-shaped book 10 may be constructed to replicate the shape of almost any vehicle or device, thereby greatly increasing the potential audience for the present invention. Therefore, the particular vehicle shapes shown in FIGS. 1-5 should be understood to be only illustrative of the types of vehicles which may be replicated by the present invention, which are only limited by the economic, manufacturing, and purchasing restrictions set by the manufacturer and the marketplace.

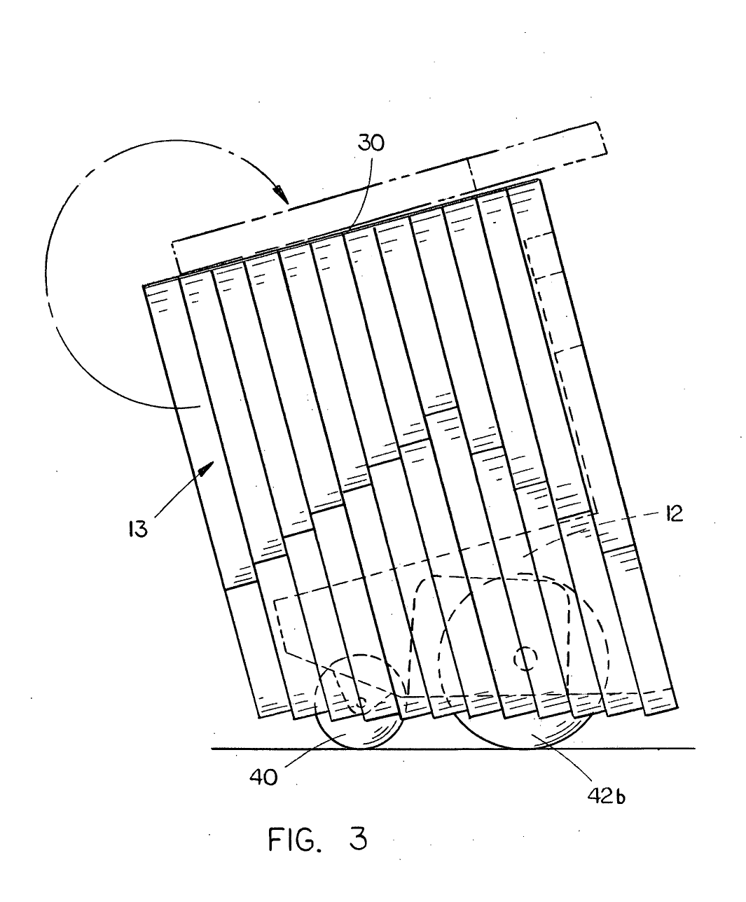

A binder 30 extends across and connects the rear edges of each of the book pages 13, as shown best in FIGS. 1, 2 and 5, and in the preferred embodiment, the binder 30 would be a reinforced paper sheet which is connected to the pages by an adhesive such as glue or the like. Of course, other types of binders may be used in connection with the vehicle-shaped book 10 of the present invention so long as the book pages 13 are secured in a book format as shown in FIGS. 1-5 and the pages are free to be opened from their closed position shown best in FIG. 1 to the open position shown in FIG. 3.

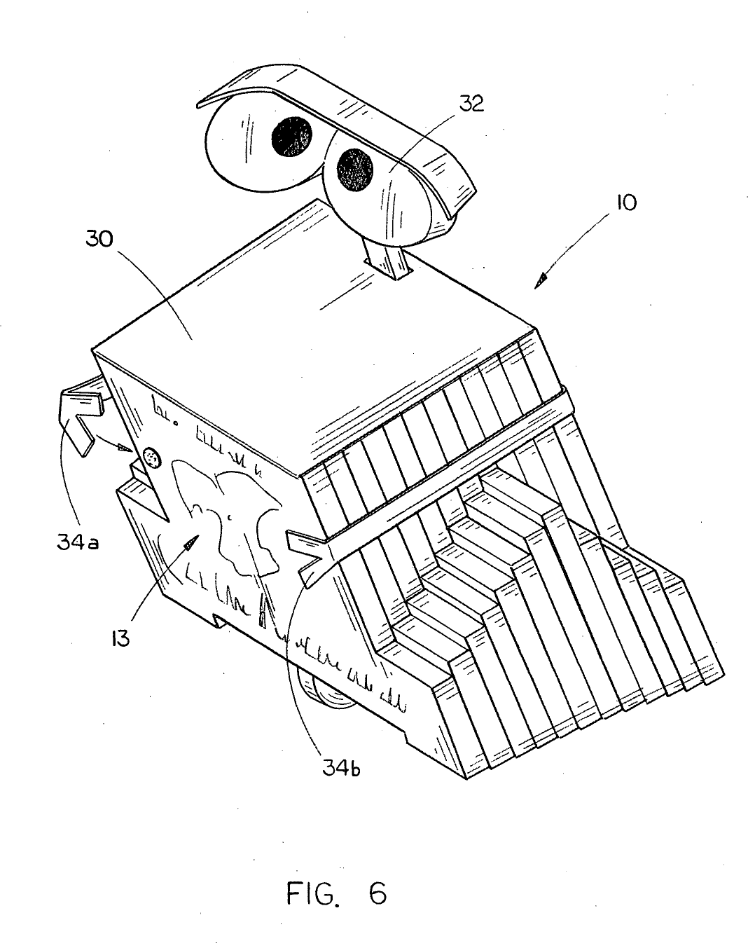

Mounted on and extending upwards from the lower chassis body 12 is a main book support strut 20, which, in the preferred embodiment, would be a rigid strut constructed of material similar to that used in connection with the lower chassis body 12 and would have a height of approximately three to ten inches. In the preferred embodiment, the plurality of book pages 13 would be mounted on the main book support strut 20 by connection to one or more of the book pages 13 or via connection to the binder 30, and the book pages 13 would extend generally perpendicular to the center longitudinal axis of the lower chassis body 12 as shown in FIGS. 1-5 such that the book pages 13 would open forwards or rearwards relative to the direction of travel of the lower chassis body 12. It should be noted that although the book pages 13 could each be of approximately the same shape, one of the unique elements of the present invention is that the book pages 13 may be of different shapes to present an overall configuration which resembles a selected vehicle or device, such as a truck, robot, automobile, or other such vehicle or device. In the embodiment shown in FIGS. 1-5, the vehicle-shaped book 10 is configured to resemble a building, whereas the embodiment of FIG. 6 is configured to resemble a robot including eyes 32 and hands 34a and 34b, although it should be noted, as was stated previously, that many different sizes and shapes and designs of vehicles and devices may be represented by the vehicle-shaped book 10 of the present invention merely by cutting the book pages 13 to the appropriate shape.

These improvements mean that not only can the user of the present invention peruse the contents printed on the book pages 13, but he or she may also play with the vehicle-shaped book 10 by rolling the book 10 over a ground surface via front and rear wheels 40, 42a and 42b. Clearly, this will significantly increase the enjoyment and excitement in reading and playing with the vehicle-shaped book 10 of the present invention, and it is believed that this increase in enjoyment will likely lead to an increased interest in reading.

In an alternative embodiment, the front wheel 40 and/or the rear wheels 42a and 42b would be connected to a mechanical or electric motor device 50 which would be mounted within the lower chassis body 12 or directly underneath the lower chassis body 12, the motor 50 operative to propel the vehicle-shaped book 10 forward over a ground surface. Numerous different types of motors 50 may be used in connection with the present invention, although it has been found that a simple mechanical motor using a flywheel, coil spring or the like would provide sufficient power to propel the vehicle-shaped book 10 of the present invention.

The vehicle-shaped book 10 of the present invention as shown in FIGS. 1-5 may further include a page securement device 46 which releasably connects an outer book page 13 to the lower chassis body 12. In the preferred embodiment, the page securement device 46 would be a hook-and-loop fastener which has one section thereof affixed to one of the outer book pages 13 and the other section affixed to the lower chassis body 12 such that upon the two sections of the hook-and-loop fastener contacting one another when the outer book page 13 is in closed position, the outer book page 13 is releasably connected to the lower chassis body 12 via the page securement device 46 to releasably secure the vehicle-shaped book 10 in its closed position as shown best in FIG. 1. Of course, many different types of securement devices may be used in connection with the present invention to secure the pages in closed position, any of which may be substituted for the page securement device 46 described herein.

The vehicle-shaped book 10 of the present invention as shown in FIGS. 1-5 may also include additional elements to replicate various styles of vehicles and devices. It should be also be noted that because the book pages 13 each include front and rear paper plates 16 and 18, as shown in FIGS. 1-5, it is a relatively simple matter to print virtually any kind of pictures, words, or other indicia 50 on the book pages 13 which will be shown in the vehicle-shaped book 10. Also, it should be noted that the same holds true if the book pages 13 are constructed of just the foam material or just of paper such as cardstock or the like, as the foam or paper material may be printed on by many different commercial printing methods, any of which would be understood by one skilled in the art of printing on alternative page construction materials. The important consideration, however, is that the vehicle-shaped book 10 may be constructed in many different sizes and shapes, and the printed materials which are printed on the book pages 13 may tie into and enhance the selected shape of the vehicle-shaped book 10.

It is to be understood that numerous additions, substitutions and modifications may be made to the vehicle-shaped book 10 of the present invention which fall within the intended broad scope of the appended claims. For example, the book pages 13 may be constructed of various types of foam materials, both including front and rear paper plates 16 and 18, or not including the paper plates, and such modifications and changes should be understood to be a part of this disclosure. Furthermore, the specific number of wheels used in connection with the present invention may be modified or changed if the vehicle intended to be replicated includes more or fewer wheels than described previously. For example, should the present invention be used to replicate a different type of robot, the vehicle-shaped book 10 could include several wheels or even could include treads such as those found on tanks and the like. Likewise, if the vehicle-shaped book 10 of the present invention were constructed to replicate a motorcycle or the like, the book would have only two wheels mounted thereon, and the appropriate connections and mountings for the selected number of wheels on the lower chassis body 12 would be understood by one skilled in the art of toy vehicle manufacturing. Finally, it should be noted that the size, shape and colors used in connection with the vehicle-shaped book 10 of the present invention may be modified or changed depending on the intended audience for the vehicle-shaped book 10, and such modifications should be understood to be a part of this disclosure.

There has therefore been shown and described an improved vehicle-shaped book 10 which accomplishes at least all of its intended objectives.

1. An improved vehicle-shaped book comprising:
a lower chassis body having a center longitudinal axis and an upper wall;
at least one wheel means rotatably mounted on said lower chassis body, said at least one wheel means having a rotational axis extending generally perpendicularly to said center longitudinal axis whereby said lower chassis body travels in a direction generally parallel with said center longitudinal axis;
a main book support strut mounted on and extending upwards from said upper wall;
at least two semi-flexible book pages;
book binding means binding said at least two book pages in a book format wherein said at least two book pages are generally parallel with one another; and
at least one of said at least two semi-flexible book pages and said book binding means mounted on said main book support strut with said at least two book pages extending generally perpendicularly to said center longitudinal axis of said lower chassis body whereby said at least two book pages extend generally perpendicularly to the direction of travel of said lower chassis body.

2. The improved vehicle-shaped book of claim 1 wherein said at least two semi-flexible book pages each are constructed as including a middle foam plate and front and back semi-rigid paper plates mounted on and sandwiching said middle foam plate.

3. The improved vehicle-shaped book of claim 2 wherein said middle foam plate is larger than said front and back semi-rigid paper plates such that said middle foam plate extends beyond the edges of said front and back paper plates whereby the edges of each of said panels are foam to generally prevent contact injuries to children handling said improved vehicle-shaped book.

4. The improved vehicle-shaped book of claim 1 wherein said book binding means comprises a reinforced paper sheet extending across and connecting top edges of each of said at least two book pages whereby said at least two book pages are secured in a book format, said pages being freely movable between a closed position aligned generally parallel with one another and an open position separated from one another.

5. The improved vehicle-shaped book of claim 4 wherein said book binding means is connected to said top edges of said at least two book pages by an adhesive substance.

6. The improved vehicle-shaped book of claim 1 wherein said lower chassis body is a generally rectangular box having an interior volume.

7. The improved vehicle-shaped book of claim 2 wherein said front and back semi-rigid paper plates further comprise indicia printed thereon.

8. The improved vehicle-shaped book of claim 1 further comprising motor means operatively connected to said at least one wheel means for propelling said vehicle-shaped book.

9. The improved vehicle-shaped book of claim 1 wherein said at least one wheel means comprises one of three and four wheels mounted on said lower chassis body in a respective tricycle or four-wheel vehicle configuration.

10. An improved vehicle-shaped book comprising:
a lower chassis body having a center longitudinal axis and an upper wall;
front and rear wheels rotatably mounted on said lower chassis body whereby said lower chassis body is rollable on said front and rear wheels;
a main book support strut mounted on and extending upwards from said upper wall,
at least two semi-flexible book pages constructed as including a middle foam plate and front and back semi-rigid paper plates mounted on and sandwiching said middle foam plate;
book binding means binding said at least two book pages in a book format wherein said at least two book pages are generally parallel with one another;
at least one of said at least two semi-flexible book pages and said book binding means mounted on said main book support strut with said at least two book pages extending generally perpendicularly to said center longitudinal axis of said lower chassis body.

11. The improved vehicle-shaped book of claim 10 wherein said middle foam plate is larger than said front and back semi-rigid paper plates such that said middle foam plate extends beyond the edges of said front and back paper plates whereby the edges of each of said panels are foam to generally prevent contact injuries to children handling said improved vehicle-shaped book.

12. The improved vehicle-shaped book of claim 10 wherein said book binding means comprises a reinforced paper sheet extending across and connecting top edges of each of said at least two book pages whereby said at least two book pages are secured in a book format, said pages being freely movable between a closed position aligned generally parallel with one another and an open position separated from one another.

13. The improved vehicle-shaped book of claim 12 wherein said book binding means is connected to said top edges of said at least two book pages by an adhesive substance.

14. The improved vehicle-shaped book of claim 10 wherein said lower chassis body is a generally rectangular box having an interior volume.

15. The improved vehicle-shaped book of claim 11 wherein said front and back semi-rigid paper plates further comprise indicia printed thereon.

16. The improved vehicle-shaped book of claim 10 further comprising motor means operatively connected to at least one of said front and rear wheels for propelling said vehicle-shaped book.

17. The improved vehicle-shaped book of claim 10 further comprising one of three and four wheels mounted on said lower chassis body in a respective tricycle or four-wheel, vehicle configuration.
